(19) United States
(12) Patent Application Publication
(10) Pub. No.: US 2007/0232510 A1
(43) Pub. Date: Oct. 4, 2007

(54) Method and composition for selectively stripping silver from a substrate

(76) Inventors: Alvin A. Kucera, Maple Grove, MN (US); Benjamin T. Carroll, Brooklyn Park, MN (US)

Correspondence Address: MCANDREWS HELD & MALLOY, LTD, 500 WEST MADISON STREET, SUITE 3400, CHICAGO, IL, 60661, US

(21) Appl. No.: 11/392,075

(22) Filed: Mar. 29, 2006

(51) Int. Cl. C23G 1/00; C11D 7/32

(52) U.S. Cl. 510/175; 134/2

(57) ABSTRACT

The current method relates to stripping silver from a printed wiring board. The steps include: providing a printed wiring board comprising a silver deposit on a surface; and contacting the silver deposit with (1) a persulfate salt, (2) an alkaline pH adjuster, and (3) an alkaline-soluble ammonium salt under conditions effective to remove at least a portion of the silver deposit from the surface. The components can be contacted with the silver deposit in an aqueous solution. In one embodiment, the solution is an aqueous solution comprising from about 5% to about 50% by weight of sodium persulfate, from about 0.001% to about 40% by weight of sodium hydroxide and from about 0.01% to about 25% by weight of ammonium hydroxide.

### RELATED APPLICATION(S)

[Not Applicable]

### FIELD OF THE INVENTION

The present technology generally relates to stripping silver from a substrate. For example, the present technology includes a method and composition for stripping silver from a printed wiring board.

### BACKGROUND OF THE INVENTION

Printed wiring boards are formed from a layer of conductive material (commonly, copper or copper plated with solder or gold) carried on a substrate of insulating material (commonly glass-fiber-reinforced epoxy resin). A printed wiring board having two conductive surfaces positioned on opposite sides of a single insulating layer is known as a “double-sided circuit board.” To accommodate even more circuits on a single board, several copper layers are sandwiched between boards or other layers of insulating material to produce a multi-layer wiring board.

Soldering is a process that is used to bond similar or dissimilar materials by melting a filler metal or alloy that is placed between the components being joined. In the manufacture of printed circuit boards, soldering is used to make electrical connections to and between printed circuits. Specifically, soldering is carried out by coating the through hole walls and other conductive surfaces of a printed wiring board with hot, molten solder to make electrical connections by wetting and filling the spaces between the conductive through hole surfaces and the leads of electrical components which have been inserted through the through holes. If the solder adheres inconsistently to the conductive surfaces, or forms too weak a bond with the conductive surfaces, the circuit board can fail or malfunction.

Soldering inconsistencies are often the result of difficulties in keeping the conductive surfaces of the printed circuit board clean and free of tarnishing (oxidation) prior to and during the soldering process. A number of treatments have been developed to preserve conductive surfaces (in particular, copper surfaces) in order to improve solderability. For example, Hot Air Solder Leveling (HASL) techniques apply a thin layer of solder to preserve the conductive surfaces and improve solderability in subsequent soldering steps. Other techniques which have been used to prevent surface oxidation and improve solderability include Electroless Nickel/Immersion Gold (ENIG), Organic Solder Preservative (OSP), immersion tin and immersion silver techniques.

Immersion silver deposits provide excellent solderability preservatives. One immersion silver technique is described in U.S. Pat. No. 6,200,451 (Redline et al.), which proposes the use of a silver plating solution with certain additives to enhance the solderability of a surface. Another immersion silver technique is described in U.S. Pat. No. 6,395,329 (Soutar et al.), which proposes the incorporation of tarnish inhibitors into an immersion plating bath. Another immersion silver solution and process is described in co-pending U.S. application Ser. No. 11/226,613, filed Sep. 14, 2005.

Despite the effectiveness of immersion silver as a solderability preservative, it is sometimes desirable to remove the silver from the underlying substrate. For example, sometimes it is desirable to plate another metal, such as nickel or gold, directly onto the copper or to apply a solder mask over a bare copper surface. In these cases the silver can be selectively removed. The deposited silver can also be removed in order to re-work faulty boards.

Previously, strong chemicals were used to strip silver. For example, chemicals such as cyanides, chromates and strong acid solutions have been employed. These chemicals pose considerable health and environmental concerns and can damage the underlying substrate, however. Thus, there is a need for stripping methods and compositions which do not employ such chemicals.

Silver has also been selectively removed using anodic current. While this approach may be effective in other industries, exposing printed wiring boards to anodic current can damage the boards.

U.S. Pat. No. 6,783,690 (Kologe) discloses a method stated to be useful for removing plated silver from a printed circuit board comprising circuit traces of a base metal covered, at least in part, by a plated silver deposit. The method includes the steps of contacting the printed circuit board with a stripping solution and then contacting the board with a neutralizing solution. Kologe discloses using sodium or potassium permanganate as oxidizing agents. These permanganates are messy due to their purple color and are toxic. Furthermore, neutralizing steps can lead to increased process time and costs. Thus, there is a need for stripping methods and compositions which do not require a neutralizing step and which employ less toxic oxidizing agents.

U.S. Pat. No. 6,238,592 (Hardy) discloses a working liquid stated to be useful in modifying a surface of a wafer suited for fabrication of a semiconductor device. The liquid is a solution of an oxidizing agent, an ionic buffer, a passivating agent and a chelating agent. However, Hardy does not teach that this working liquid can be used to strip silver.

Accordingly, it would be desirable to provide a method and composition for selectively stripping silver from a printed wiring board without removing a significant amount of the underlying substrate. It also would be desirable that the stripping method and composition not require toxic chemicals or a neutralizing step, which can lead to safety concern and increased production costs.

### SUMMARY OF THE INVENTION

The current method relates to stripping silver from a printed wiring board. The steps include: providing a printed wiring board comprising a silver deposit on a surface; and contacting the silver deposit with (1) a persulfate salt, (2) an alkaline pH adjuster, and (3) an alkaline-soluble ammonium salt under conditions effective to remove at least a portion of the silver deposit from the surface.

The current composition relates to a stripping solution comprising (1) a persulfate salt, (2) an alkaline pH adjuster, and (3) an alkaline-soluble ammonium salt present in amounts effective to strip silver.

Another current composition relates to an aqueous solution comprising from about 5% to about 50% by weight of sodium persulfate, from about 0.001% to about 40% by weight of sodium hydroxide and from about 0.01% to about 25% by weight of ammonium hydroxide.

### DETAILED DESCRIPTION OF THE PREFERRED EMBODIMENT(S)

The present method and composition can selectively strip silver from a printed wiring board or other substrate without removing a significant amount of the underlying substrate. The embodiments disclosed herein are intended to be illustrative and it will be understood that the invention is not limited the these embodiments since modification can be made by those of skill in the art without departing from the scope of the present disclosure.

The method of selectively stripping silver begins with providing a printed wiring board (or other substrate) having a silver deposit on a surface. A common surface for printed wiring boards is copper. However, other surfaces such as nickel, brass, gold, copper alloys and non-metallic substrates can also be used. Silver can be deposited on the surface using a method known in the art. For example, the silver can be deposited using an immersion silver process, such as the process described in co-pending U.S. application Ser. No. 11/226,613. Other methods of depositing silver onto the surface include those methods outlined in U.S. Pat. No. 6,200,431 (Redline et al.) and U.S. Pat. No. 6,395,329 (Soutar et. al.). These and other methods of depositing silver are known in the art.

The silver deposit is then contacted with (1) a persulfate salt, (2) an alkaline pH adjuster, and (3) an alkaline-soluble ammonium salt under conditions effective to remove at least a portion of the silver deposit from the surface. Suitable persulfate salts, alkaline pH adjusters, and alkaline-soluble ammonium salts known to those familiar with the technology may be used in the present method and composition. Possible persulfate salts include sodium persulfate (Na₂S₂O₈), ammonium persulfate ((NH₄)₂S₂O₈), or potassium peroxymonosulfate (2KHSO₅.KHSO₄.K₂SO₄). Possible pH adjusters include carbonates and alkaline hydroxide containing chemicals such as sodium hydroxide (NaOH) and potassium hydroxide (KOH). Possible alkaline-soluble ammonium salts include ammonium hydroxide (NH₄OH), ammonium carbonate (NH₄HCO₃) and ammonium bicarbonate ((NH₄)₂CO₃).

The persulfate salt, alkaline pH adjuster and alkaline-soluble ammonium salt will generally be contacted with the silver deposit as a combined solution. Although, other suitable contacting modes known to those familiar with the technology may be employed.

In certain embodiments the conditions are such that all or substantially all of the silver deposit is removed and the underlying surface is bright, uniform and not significantly etched after the contacting step. This allows for re-working. Specifically, it allows a new layer of silver or other metal to be deposited onto the surface. In other embodiments less than all of the silver deposit can be removed.

Conditions that can affect silver removal and the quality of the underlying surface include the concentration of the components that are placed into contact with the silver deposit. For example, when a combined aqueous solution is employed, the persulfate salt can be present in the solution in an amount from about 5% to about 50% by weight, or alternatively from about 10% to about 35% by weight. As yet another alternative, the persulfate salt can be present in an amount from about 15% to about 25% by weight, or alternatively at about 20% by weight.

The alkaline pH adjuster can be present in the solution in an amount from about 0.001% to about 40% by weight, or alternatively from about 0.75% to about 20% by weight. As yet another alternative, the alkaline pH adjuster can be present in the solution in an amount from about 1% to about 4% by weight, or alternatively at about 2% by weight.

The alkaline-soluble ammonium salt can be present in the solution in an amount from about 0.01% to about 25% by weight, or alternatively from about 0.03% to about 10% by weight. As yet another alternative, the alkaline-soluble ammonium salt can be present in the solution in an amount from about 0.05% to about 5% by weight, or alternatively at about 0.15% by weight.

The temperature at which contacting occurs can also affect the silver removal and the quality of the underlying surface. In one embodiment the contacting occurs at a temperature between about 65 and about 160° F. (18 and 71° C.). Alternatively, contact can occur at a temperature between about 85 and about 140° F. (29 and 60° C.). As yet another alternative contact can occur at a temperature between about 110 to about 130° F. (43 and 54° C.).

The length of the contacting time also affects the silver removal and the quality of the underlying surface. The silver can be contacted for a time effective to remove all or substantially all of the silver deposit from at least a portion of the surface. In another embodiment the contact duration can be in the range of about 0.1 to 30 minutes, or alternatively in the range of about 0.5 to about 10 minutes. As yet another alternative, the contacting time can be in the range of about 1 to about 3 minutes.

Yet another condition that can affect the removal of the silver and the quality of the underlying surface is the pH level at which contacting occurs. In one embodiment the contacting occurs at a pH of about 11 to about 14, or alternatively about 12.5 to about 13.5. In yet another alternative contacting occurs at a pH of about 13.0 to about 13.5. Alternatively the contacting step can occur at a pH of greater than about 7.

A person familiar with the technology will understand that the conditions described above can be varied and adjusted to achieve the desired degree of silver removal.

The contacting step may be carried out in a suitable manner known to those familiar with the technology. For example, the contacting step can be carried out by immersing the silver deposit in a bath. A bath can be created by combining the persulfate salt, the alkaline pH adjuster and the alkaline-soluble ammonium salt in an aqueous solution. The silver deposit is then immersed into the bath. It may be desirable to replenish certain components in the bath as they are used up (this may be desirable if the bath is used more than once, for example). Typically, the persulfate salt is used up more quickly than the other two components and can be replenished more often. In addition, all three components can be replenished when silver uptake reduces the efficiency.

After the contacting step, a neutralizing step is not required. This not only offers advantages from a safety standpoint, but also reduces costs by omitting an entire processing step.

In one embodiment, the contacting step is followed by an optional rinsing step. The rinsing step involves contacting the board with water (even tap water can be used). This rinsing step can be carried out at a temperature between about 50 and about 100° F. (10 and 38° C.), or alternatively greater than about 50° F. (10° C.). The rinsing step can last for about 0.5 to about 3 minutes, or alternatively for greater than 0.5 minutes. The board can be dipped into a rinsing tub. Alternatively, water can be contacted with the board at a flow rate of between 0.5 and 5 gallons/minute (1.9 and 18.9 L/minute), or alternatively 1 to 1.5 gallons/minute (3.8 and 5.7 L/minute). As will be evident to one familiar with the technology, a process employing a rinsing step offers significant cost and safety benefits over processes requiring a neutralizing step.

In one embodiment, the contacting step and optional rinsing step can be followed by an optional drying step. The drying step acts to dry the underlying surface after the silver removal. The drying step can be carried out by exposing the surface to a temperature between about 100 and about 200° F. (38 and 93° C.) until dry, or alternatively using a temperature between about 130 and about 180° F. (54 and 82° C.). One possible drying method involves blowing heated forced air onto the board.

The current aqueous solution comprises a persulfate salt, an alkaline pH adjuster and an alkaline-soluble ammonium salt present in amounts effective to strip silver. Contemplated persulfate salts include sodium persulfate (Na₂S₂O₈), ammonium persulfate ((NH₄)₂S₂O₈), or potassium peroxymonosulfate (2KHSO₅.KHSO₄.K₂SO₄). Contemplated alkaline pH adjusters include carbonates and alkaline hydroxide containing chemicals such as sodium hydroxide (NaOH) and potassium hydroxide (KOH). Possible alkaline-soluble ammonium salts include ammonium hydroxide (NH₄OH), ammonium carbonate (NH₄HCO₃) and ammonium bicarbonate ((NH₄)₂CO₃).

An embodiment of the aqueous solution is made up of from about 5% to about 50% by weight of sodium persulfate, ammonium persulfate, or potassium peroxymonosulfate, from about 0.001% to about 40% by weight of sodium hydroxide and from about 0.01% to about 25% by weight of ammonium hydroxide. In another embodiment the aqueous solutions is made up from about 10% to about 35% by weight of sodium persulfate, ammonium persulfate, or potassium peroxymonosulfate, from about 0.75% to about 20% by weight sodium hydroxide and from about 0.03% to about 10% by weight of ammonium hydroxide. In yet another embodiment the aqueous solutions is made up from about 15% to about 25% by weight of sodium persulfate, ammonium persulfate, or potassium peroxymonosulfate, from about 1% to about 4% by weight sodium hydroxide and from about 0.05% to about 5% by weight of ammonium hydroxide. Alternatively, the aqueous solutions is made up of about 20% by weight of sodium persulfate, ammonium persulfate, or potassium peroxymonosulfate, about 2% by weight sodium hydroxide and about 0.15% by weight of ammonium hydroxide.

In one embodiment only (1) a persulfate salt, (2) an alkaline pH adjuster and (3) an alkaline-soluble ammonium salt are present in amounts effective to strip silver. In other embodiments optional components that will not compromise the silvers stripping process can also be added. Such optional components will by apparent to those familiar with the technology.

### EXAMPLE 1

In one non-limiting embodiment, a bath containing 20% by weight sodium persulfate, 2% by weight sodium hydroxide and 0.15% by weight ammonium hydroxide, was prepared. A printed wiring board including a copper circuit trace with a silver deposit applied according to an immersion silver process was contacted with the bath by immersing it for 1 minute at a temperature of 100° F. (38° C.). A pH of between 13 and 13.5 was maintained. Next, the printed wiring board was rinsed with water at ambient temperature for 0.5 minutes.

The silver was found to be selectively removed from the printed wiring board. The copper was bright and not significantly etched. The copper surface was ready for re-working.

### EXAMPLE 2

In one non-limiting embodiment, a bath containing 20% by weight sodium persulfate, 2% by weight sodium hydroxide and 0.15% by weight ammonium hydroxide, was prepared. A printed wiring board including a copper circuit trace with a silver deposit applied according to an immersion silver process was contacted with the bath by immersing it for 2 minutes at a temperature of 100° F. (38° C.). A pH of between 13 and 13.5 was maintained. Next, the printed wiring board was rinsed with water at ambient temperature for 0.5 minutes.

The silver was found to be selectively removed from the printed wiring board. The copper was bright and not significantly etched. The copper surface was ready for re-working.

### EXAMPLE 3

In one non-limiting embodiment, a bath containing 35% by weight sodium persulfate, 5% by weight sodium hydroxide and 2% by weight ammonium hydroxide, is prepared. A printed wiring board including a copper circuit trace with a silver deposit applied according to an immersion silver process is contacted with the bath by immersing it for 2 minutes at a temperature of 110° F. (43° C.). A pH of between 13 and 13.5 is maintained. Next, the printed wiring board is rinsed at ambient temperature for 0.5 minutes. Finally, the printed wiring board is dried using heated forced air at 100° F. (38° C.).

After being contacted with the bath, the silver is found to be selectively removed from the printed wiring board. The copper is bright and not significantly etched. The copper surface is ready for re-working.

### EXAMPLE 4

In one non-limiting embodiment, a bath containing 15% by weight potassium peroxymonosulfate, 1% by weight potassium hydroxide and 0.25% by weight ammonium carbonate, is prepared. A printed wiring board including a copper circuit trace with a silver deposit applied according to an immersion silver process is contacted with the bath by immersing it for 2 minutes at a temperature of 130° F. (54° C.). A pH of between 13 and 13.5 is maintained. Next, the printed wiring board is rinsed at ambient temperature for 0.5 minutes. Finally, the printed wiring board is dried using heated forced air at 100° F. (38° C.).

After being contacted with the bath, the silver is found to be selectively removed from the printed wiring board. The copper is bright and not significantly etched. The copper surface is ready for re-working.

While particular elements, embodiments and applications have been shown and described, it will be understood, of course, that the invention is not limited thereto since modification can be made by those of skill in the art without departing from the scope of the present disclosure, particularly in light of the foregoing teachings.

What is claimed is:

1. A method of stripping silver from a printed wiring board, comprising the steps of:
providing a printed wiring board comprising a silver deposit on a surface; and
contacting said silver deposit with
a persulfate salt,
an alkaline pH adjuster, and
an alkaline-soluble ammonium salt;
under conditions effective to remove at least a portion of the silver deposit from said surface.

2. The method of claim 1 wherein said persulfate salt is selected from a group consisting of sodium persulfate, ammonium persulfate, and potassium peroxymonosulfate.

3. The method of claim 1 wherein said alkaline pH adjuster is sodium hydroxide.

4. The method of claim 1 wherein said alkaline-soluble ammonium salt is ammonium hydroxide.

5. The method of claim 1 wherein said contacting step occurs between about 65° F. and about 160° F. (18 and 71° C.).

6. The method of claim 1 wherein the duration of said contacting step is from about 0.1 to about 30 minutes.

7. The method of claim 1 wherein said surface comprises copper.

8. The method of claim 1 wherein said surface is bright after said contacting step.

9. The method of claim 1 wherein said surface is uniform after said contacting step.

10. The method of claim 1 wherein said surface is ready for re working after said contacting step.

11. The method of claim 1 wherein said surface is not significantly etched after said contacting step.

12. The method of claim 1 wherein said contacting step is carried out by forming a bath of said persulfate salt, said alkaline pH adjuster, and said alkaline-soluble ammonium salt in aqueous solution and immersing said silver deposit in said bath.

13. The method of claim 1 wherein said conditions are effective to remove substantially all of said silver deposit from at least a portion of said surface.

14. The method of claim 1 further comprising the step of rinsing said surface with water.

15. The method of claim 14 further comprising the step of drying said surface.

16. The method of claim 1 wherein said contacting step occurs at a pH of at least about 7.

17. An aqueous solution comprising:
a persulfate salt,
an alkaline pH adjuster, and
an alkaline-soluble ammonium salt;
wherein said solution is effective for stripping silver.

18. The solution of claim 17 wherein said persulfate salt is selected from a group consisting of sodium persulfate, ammonium persulfate, and potassium peroxymonosulfate.

19. The solution of claim 17 wherein said alkaline pH adjuster is sodium hydroxide.

20. The solution of claim 17 wherein said alkaline-soluble ammonium salt is ammonium hydroxide.

21. An aqueous solution comprising from about 5% to about 50% by weight sodium persulfate, from about 0.001% to about 40% by weight of sodium hydroxide and from about 0.01% to about 25% by weight of ammonium hydroxide.
